(19) United States
(12) Patent Application Publication
(10) Pub. No.: US 2023/0110049 A1
(43) Pub. Date: Apr. 13, 2023

(54) LIMITING THE SECURITY IMPACT OF COMPROMISED ENDPOINT COMPUTING DEVICES IN A DISTRIBUTED MALWARE DETECTION SYSTEM

(71) Applicant: VMware, Inc., Palo Alto, CA (US)

(72) Inventors: Anand Jaysingh BHALERAO, Pune (IN); Vaibhav KULKARNI, Pune (IN); Taher BARODAWALA, Karnataka (IN)

(21) Appl. No.: 17/450,738

(22) Filed: Oct. 13, 2021

(51) Int. Cl. G06F 21/56; G06F 21/55

(52) U.S. Cl. CPC G06F 21/565; G06F 21/568; G06F 21/554; G06F 21/552

(57) ABSTRACT

A method for detecting malware in a distributed malware detection system comprising a plurality of endpoints, is provided. The method generally includes inspecting, at a first endpoint of the plurality of endpoints, a file classified as an unknown file; based on the inspecting, determining, at the first endpoint, a first verdict for the file, the first verdict indicating the file is benign or malicious; determining whether an aggregate number of verdicts for the file from the plurality of endpoints, including the first verdict, meets a first threshold; and selectively reclassifying the file as benign or malicious based on whether the aggregate number of verdicts for the file meets the first threshold.

### BACKGROUND

Today's enterprises rely on defense-in-depth mechanisms (e.g., multiple layers of security defense controls used to provide redundancy in the event a security control fails) to protect endpoint computing devices from malware infection. Malware is malicious software that, for example, disrupts network operations and gathers sensitive information on behalf of an unauthorized third party. Targeted malware may employ sophisticated methodology and embed in the target's infrastructure to carry out undetected malicious activities. In particular, once malware gains access to an endpoint, the malware may attempt to control the device and use lateral movement mechanisms to spread to other endpoints and critical assets of an enterprise.

Anti-malware solutions are employed to detect and prevent malware from infiltrating such endpoint computing devices in a system using various techniques, such as, sandboxing of malware samples, signature based detection of known malwares, and blocking of malwares from spreading in the environment.

Sandboxing is a software management strategy used to identify zero day malware threats (e.g., threats not previously known about or anticipated). In particular, sandboxing proactively detects malware by executing files in a safe and isolated environment to observe that file's behavior and output activity. Traditional security measures are reactive and based on signature detection—which works by looking for patterns identified in known instances of malware. Because traditional security measures detect only previously identified threats, sandboxes add another layer of security.

With the use of sandboxing techniques, files are analyzed to derive a verdict, such as BENIGN, MALICIOUS, etc. As used herein, a file that is analyzed may include a file opened by another application, an executable application or code, and/or the like. Where the sandboxing evaluation finds that the executed file modifies system files or infects the system in any way, those issues may not spread to other areas given the isolated nature of the sandbox environment. Accordingly, a verdict of MALICIOUS may be assigned to the file indicating the sample is malware and poses a security threat. On the other hand, where the sandboxing evaluation finds that the executed file is safe and does not exhibit malicious behavior, a verdict of BENIGN may be assigned. Such derived verdicts may be used to take appropriate policy action, for example, to enable blocking or access to the files by endpoints in the system.

In some implementations, a centralized sandboxing model is deployed where a single endpoint computing device in the system is used to inspect and analyze files, from all endpoints, stored in a shared file repository for verdict determination. However, such centralized models may not be efficient given only a single endpoint is capable of providing verdicts for all files in the system. In turn, inefficient sandboxing may provide a file, which is in fact a malware file but has not yet been identified as a malware file, a substantial amount of time to cause damage at an endpoint. Further, centralized models require additional coordination between endpoints, and often, necessitate a central service to ensure completeness of each file transfer to the repository for verdict determination. Additionally, copying files using secure protocols from each endpoint to a defined storage repository adds significant latency to the workflow, as compared to local file access. For these reasons, a centralized model for file inspection and verdict determination may be undesirable.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 depicts example physical and virtual components in a networking environment in which embodiments of the present disclosure may be implemented.

FIGS. 2A and 2B illustrate an example workflow for evaluating files in a distributed malware detection system, according to an example embodiment of the present application.

FIG. 3 illustrates an example table of verdicts for files evaluated in a distributed malware detection system, according to an example embodiment of the present application.

FIG. 4 illustrates an example workflow for confirming endpoint identity, according to an example embodiment of the present disclosure.

### DETAILED DESCRIPTION

Aspects of the present disclosure introduce a distributed malware detection system designed to limit the security impact of one or more compromised endpoints in the system. In particular, a distributed malware detection system involves decentralized architecture where resources on two or more endpoints are leveraged to run multiple instances of a sandbox. In cybersecurity, sandboxes are used to safely execute suspicious files without risking harm to an endpoint or network. Thus, each endpoint in the distributed system may be configured to isolate and examine suspicious and/or unknown files and produce a verdict regarding the safety of the file. A file maybe “suspicious” or “unknown” when it has not previously been identified as BENIGN or MALICIOUS, such as based on a previous verification. By taking a distributed approach, a file is inspected more quickly, as compared to a centralized implementation, such as to isolate and remove a wide range of malware.

In some distributed malware detection systems, all endpoints running an instance of the sandbox are treated equally. In other words, there is shared trust amongst all endpoints involved in the sandboxing process such that a verdict determined by one endpoint may be trusted by all other endpoints. Hence, a verdict determined by one endpoint is used universally to take appropriate policy action, for example, to enable blocking or access to the file by each endpoint. This also means that once a file is inspected by one endpoint in the system, the file need not be inspected again by another endpoint (at least until the time to live (TTL) of the verdict associated with the file expires).

Such an arrangement, however, fails where an attacker finds a way to circumvent one or more endpoints in the system, such as by delivering malware or exploiting vulnerabilities of an endpoint. If an endpoint running an instance of a sandbox is compromised by a malicious actor, then such compromise may have a profound impact on the entire system. For example, a compromised endpoint may leverage a pre-established communication channel between all endpoints to publish incorrect/compromised verdicts for files for the purpose of infiltrating other endpoints in the system.

For example, in some cases, a compromised endpoint may publish a BENIGN verdict for a MALICIOUS file. Given the shared trust among endpoints in the system, a second inspection of the file would not be performed by the other endpoints, and instead, the other endpoints would take this BENIGN verdict at face value. Accordingly, the false BENIGN verdict published by the compromised endpoint would grant the MALICIOUS file access to all other endpoints in the system where the file is executed. In other words, the compromised endpoint would be successful at granting a file unauthorized access to other endpoints in the system.

As another example, in some cases, a compromised endpoint may publish a MALICIOUS verdict for a BENIGN file. Given the shared trust among endpoints in the system, a second inspection of the file would not be performed by the other endpoints, and instead, the other endpoints would take this MALICIOUS verdict at face value. Accordingly, the false MALICIOUS verdict published by the compromised endpoint would prevent access to the inherently secure file by other endpoints in the system. In other words, the compromised endpoint would be successful at performing a denial-of-service (DOS) attack making the file unavailable to its intended users, thereby disrupting services at each of these intended users.

Accordingly, certain embodiments described herein provide a solution to the technical problem described above by introducing thresholds associated with each verdict. The thresholds set a minimum number of endpoints in the system running an instance of the sandbox required to produce a same verdict for the same file before the verdict associated with the file is published to all endpoints in the system. The use of such thresholds allow files to be inspected by multiple endpoints for derivation of a consensus-based verdict thereby reducing the impact of a compromised verdict published by a compromised endpoint in the system. In some embodiments, additional techniques are introduced for identifying suspect endpoints and limiting the impact of such verdicts produced by these identified endpoints to maintain the integrity of the system.

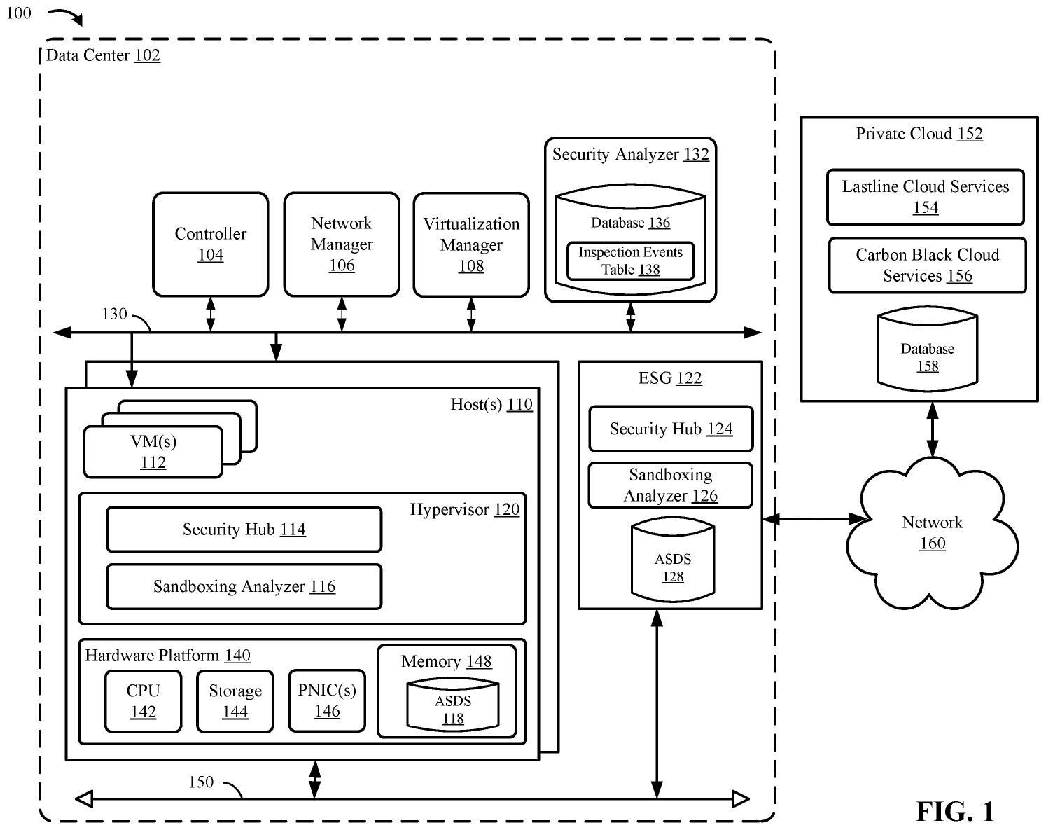

FIG. 1 depicts example physical and virtual network components in a networking environment 100 in which embodiments of the present disclosure may be implemented. As shown in FIG. 1, networking environment 100 may be distributed across a hybrid cloud. A hybrid cloud is a type of cloud computing that combines on-premises infrastructure, e.g., a private cloud 152 comprising one or more physical computing devices (e.g., running one or more virtual computing instances (VCIs)) on which the processes shown run, with a public cloud, or data center 102, comprising one or more physical computing devices (e.g., running one or more VCIs) on which the processes shown run. Hybrid clouds allow data and applications to move between the two environments. Many organizations choose a hybrid cloud approach due to organization imperatives such as meeting regulatory and data sovereignty requirements, taking full advantage of on-premises technology investment, or addressing low latency issues.

Data center 102 and private cloud 152 may communicate via a network 160. Network 160 may be an external network. Network 160 may be a layer 3 (L3) physical network. Network 160 may be a public network, a wide area network (WAN) such as the Internet, a direct link, a local area network (LAN), another type of network, or a combination of these.

Data center 102 includes one or more hosts 110, an edge services gateway (ESG) 122, a management network 130, a data network 150, a controller 104, a network manager 106, a virtualization manager 108, and a security analyzer 132. Data network 150 and management network 130 may be implemented as separate physical networks or as separate virtual local area networks (VLANs) on the same physical network.

Host(s) 110 may be communicatively connected to both data network 150 and management network 130. Data network 150 and management network 130 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Each of hosts 110 may be constructed on a server grade hardware platform 140, such as an x86 architecture platform. Hosts 110 may be geographically co-located servers on the same rack or on different racks. Hardware platform 140 of a host 110 may include components of a computing device such as one or more processors (CPUs) 142, storage 144, one or more network interfaces (e.g., physical network interface cards (PNICs) 146), system memory 148, and other components (not shown). A CPU 142 is configured to execute instructions, for example, executable instructions that perform one or more operations described herein and that may be stored in the memory and storage system. The network interface(s) enable host 110 to communicate with other devices via a physical network, such as management network 130 and data network 150.

Each host 110 is configured to provide a virtualization layer, also referred to as a hypervisor 120. Hypervisors abstract processor, memory, storage, and networking physical resources of hardware platform 140 into a number of VCIs or virtual machines (VMs) 112(1) . . . (x) (collectively referred to as VMs 112) on hosts 110. As shown, multiple VMs 112 may run concurrently on the same host 110.

Each hypervisor may run in conjunction with an operating system (OS) in its respective host 110. In some embodiments, hypervisors can be installed as system level software directly on hardware platforms of its respective host 110 (e.g., referred to as “bare metal” installation) and be conceptually interposed between the physical hardware and the guest OSs executing in the VMs 112. Though certain aspects are described herein with respect to VMs 112 running on host machines 110, it should be understood that such aspects are similarly applicable to physical machines, like host machines 110, without the use of virtualization.

ESG 122 is configured to operate as a gateway device that provides components in data center 102 with connectivity to an external network, such as network 160. ESG 122 may be addressable using addressing of the physical underlay network (e.g., data network 150). ESG 122 may manage external public IP addresses for VMs 112. ESG 122 may include a router (e.g., a virtual router and/or a virtual switch) that routes traffic incoming to and outgoing from data center 102. ESG 122 also provides other networking services, such as firewalls, network address translation (NAT), dynamic host configuration protocol (DHCP), and load balancing. ESG 122 may be referred to as a nested transport node, for example, as the ESG VM 122 does encapsulation and decapsulation. ESG 122 may be a stripped down version of a Linux transport node, with the hypervisor module removed, tuned for fast routing. The term, “transport node” refers to a virtual or physical computing device that is capable of performing packet encapsulation/decapsulation for communicating overlay traffic on an underlay network.

While ESG 122 is illustrated in FIG. 1 as a component outside of host 110, in some embodiments, ESG 122 may be situated on host 110 and provide networking services, such as firewalls, NAT, DHCP, and load balancing services as a service VM (SVM).

In certain embodiments, a security hub, a sandboxing analyzer, and an advance signature distribution service (ASDS) cache may be implemented on one or more hosts 110 and/or ESG 122 for the purpose of detecting malware and other security threats in data center 102.

In particular, a sandboxing analyzer may be implemented in data center 102 to perform static and dynamic analysis of files on each of hosts 110 and/or ESG 122. Such files may be analyzed, for example, when downloaded to a host 110 or ESG 122, when added to a host 110 or ESG 122, before execution on a host 110 or ESG 122, and/or the like. Static analysis is performed for quick scanning of files to determine any malicious behavior. Performing static analysis is a way to detect malicious code or infections within the file. On the other hand, dynamic analysis monitors the actions of a file when the file is being executed. Dynamic analysis may also be referred to as behavior analysis because the overall behavior of the sample is captured in the execution phase. The sandboxing analyzer may perform dynamic analysis in a “sandbox”, or in other words, an isolated environment, to ensure that components of data center 102 are not affected in cases where the file executed for analysis contains malware (e.g., is a MALICIOUS file).

The sandboxing analyzer implemented in data center 102 may run in isolated user spaces on multiple hosts 110 and/or ESGs 122, the isolated user spaces generally referred to as containers. Each container is an executable package of software running on top of a host 110 OS or ESG 122. In certain aspects, each host 110 and/or ESG 122 in data center 102 and/or private cloud 152 is used to run a sandboxing analyzer in a container. In certain aspects, a subset of hosts 110 and/or ESGs 122 in data center 102 and/or private cloud 152 is used to run a sandboxing analyzer in a container. In certain aspects, the sandboxing analyzer is implemented in a single container on a given host 110 and/or ESG 122. In certain aspects, the sandboxing analyzer is implemented on multiple containers on a given host 110 and/or ESG 122 In other words, one or more containers per endpoint (e.g., host 110 and/or ESG 122) are used to perform sandboxing as a distributed application. Thus, distributed sandboxing may be performed by the example implementation illustrated in FIG. 1. As shown in FIG. 1, ESG 122 may include sandboxing analyzer 126, and hypervisor 120 of host 110 may include sandboxing analyzer 116. While sandboxing analyzer 116 is implemented as a component on hypervisor 120, in some other embodiments, sandboxing analyzer 116 may be implemented in a VM such as an SVM on host 110, or on an OS of host 110.

To execute such static and dynamic analyses on each host 110 and/or ESG 122 where sandboxing analyzer 116 and/or sandboxing analyzer 126, respectively, is running, a security hub is implemented. More specifically, security hub 114 may be implemented as a component on hypervisor 120 of host 110 and/or security hub 124 may be implemented on ESG 122. According to certain aspects described herein, security hubs 114, 124 may be configured to retrieve verdicts for known files on each of hosts 110 and ESG 122, respectively. A known file may refer to a file for which a verdict is known, such as through a previous inspection or sandboxing. Security hub 114 may retrieve verdicts from ASDS cache 118 stored in physical memory (e.g., random access memory (RAM)) configured within host 110, while security hub 124 may retrieve verdicts from ASDS cache 128 stored on ESG 122. ASDS caches 118, 128 act as small, fast memories that store files hashes for recently accessed and inspected files and their associated verdicts. Security hubs 114, 124 may use ASDS caches 118, 128, respectively, to retrieve verdicts for previously inspected files without accessing database 136 stored on security analyzer 132, which is described in more detail below. Accordingly, data requests satisfied by the cache are executed with less latency as the latency associated with accessing the database 136 is avoided.

According to certain aspects described herein, security hubs 114, 124 may also be configured to select files on each of hosts 110 and ESG 122 for sandboxing. For example, security hub 124 implemented on ESG 122 may interact with a network intrusion detection and prevention system (IDPS) (e.g., used to monitor network activities for malicious activity) to determine which files are to be analyzed. Similarly, security hub 114 implemented on hypervisor 120 of host 110 may interact with VMs 112 to determine which files are to be analyzed. Security hubs 114, 124 may trigger the sandboxing of such files.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

The control plane determines the logical overlay network topology and maintains information about network entities such as logical switches, logical routers, and endpoints, etc. The logical topology information is translated by the control plane into network configuration data that is then communicated to network elements of host(s) 110. Controller 104 generally represents a control plane that manages configuration of VMs 112 within data center 102. Controller 104 may be one of multiple controllers executing on various hosts in the data center that together implement the functions of the control plane in a distributed manner. Controller 104 may be a computer program that resides and executes in a central server in the data center or, alternatively, controller 104 may run as a virtual appliance (e.g., a VM) in one of hosts 110. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of the data center. Controller 104 communicates with hosts 110 via management network 130, such as through control plane protocols. In some embodiments, controller 104 implements a central control plane (CCP).

Network manager 106 and virtualization manager 108 generally represent components of a management plane comprising one or more computing devices responsible for receiving logical network configuration inputs, such as from a user or network administrator, defining one or more endpoints (e.g., VCIs) and the connections between the endpoints, as well as rules governing communications between various endpoints.

In some embodiments, virtualization manager 108 is a computer program that executes in a central server in the data center (e.g., the same or a different server than the server on which network manager 106 executes), or alternatively, virtualization manager 108 runs in one of VMs 112. Virtualization manager 108 is configured to carry out administrative tasks for the data center, including managing hosts 110, managing VMs running within each host 110, provisioning VMs, transferring VMs from one host to another host, transferring VMs between data centers, transferring application instances between VMs or between hosts 110, and load balancing among hosts 110 within the data center. Virtualization manager 108 takes commands as to creation, migration, and deletion decisions of VMs and application instances on the data center. However, virtualization manager 108 also makes independent decisions on management of local VMs and application instances, such as placement of VMs and application instances between hosts 110. In some embodiments, virtualization manager 108 also includes a migration component that performs migration of VMs between hosts 110, such as by live migration.

In some embodiments, network manager 106 is a computer program that executes in a central server in networking environment 100, or alternatively, network manager 106 may run in a VM, e.g., in one of hosts 110. Network manager 106 communicates with host(s) 110 via management network 130. Network manager 106 may receive network configuration input from a user or an administrator and generate desired state data that specifies how a logical network should be implemented in the physical infrastructure of the data center. Further, in certain embodiments, network manager may receive security configuration input (e.g., security policy information) from a user or an administrator and configure hosts 110 and ESG 122 according to this input. As described in more detail below, policies configured at hosts 110 and ESG 122 may indicate what action is to be taken when a file is determined to be BENIGN or MALICIOUS.

Network manager 106 is configured to receive inputs from an administrator or other entity, e.g., via a web interface or application programming interface (API), and carry out administrative tasks for the data center, including centralized network management and providing an aggregated system view for a user.

In certain embodiments, a security analyzer 132 may be implemented as an additional component of the management plane. Security analyzer 132 may maintain a database 136 of verdicts for files inspected by hosts 110 and/or ESG 122. In certain embodiments, database 136 has an inspection events table 138 for storing file hashes and associated verdicts produced by one or more hosts 110 and/or ESG 122 for each of the files inspected. Inspection events table 138 may include multiple tables, each corresponding to a different file hash. Rows of each of the multiple tables in inspection events table 138 may be used to store host 110 and/or ESG 122 identification information as well as verdicts produced by hosts 110 and/or ESG 122. It should be noted that inspection events table 138 is only one example of a data structure for maintaining file hashes and associated verdicts, and that any suitable data structure(s) may be used, including other tables, arrays, bitmaps, hash maps, etc.

Security analyzer 132 may also maintain in its database 136, verdicts produced by other trusted sources, which may be stored in any suitable data structure(s). Examples of other trusted sources that are implemented to inspect files and provide verdicts for such files include Lastline cloud services 154 and Carbon Black cloud services 156 made commercially available from VMware, Inc. of Palo Alto, Calif. Lastline cloud services 154 and Carbon Black cloud services 156 provide security software that is designed to detect malicious behavior and help prevent malicious files from attacking an organization. Verdicts produced by Lastline cloud services 154 and Carbon Black cloud services 156 may be stored in database 158 on private cloud 152, as well as in database 136. As described in more detail below, verdicts produced by other trusted sources, such as Lastline cloud services 154 and/or Carbon Black cloud services 156, may take precedence over verdicts produced by hosts 110 and ESG 122 in data center 102 for a same file.

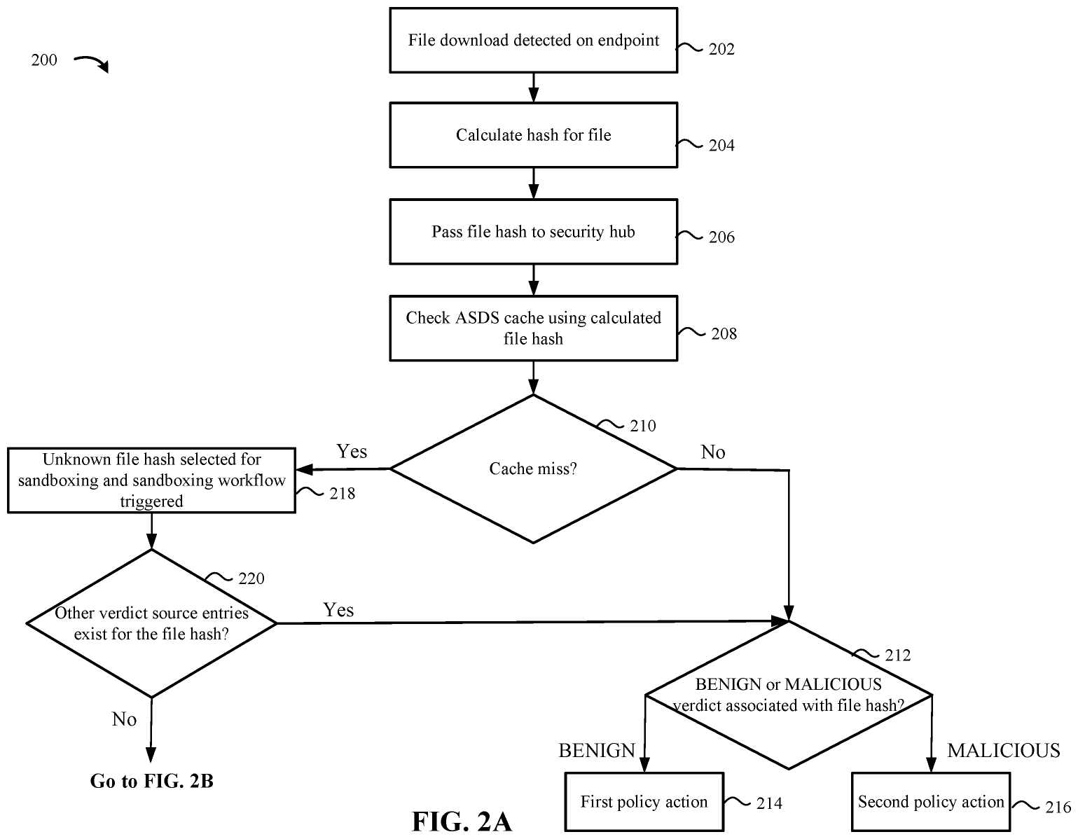

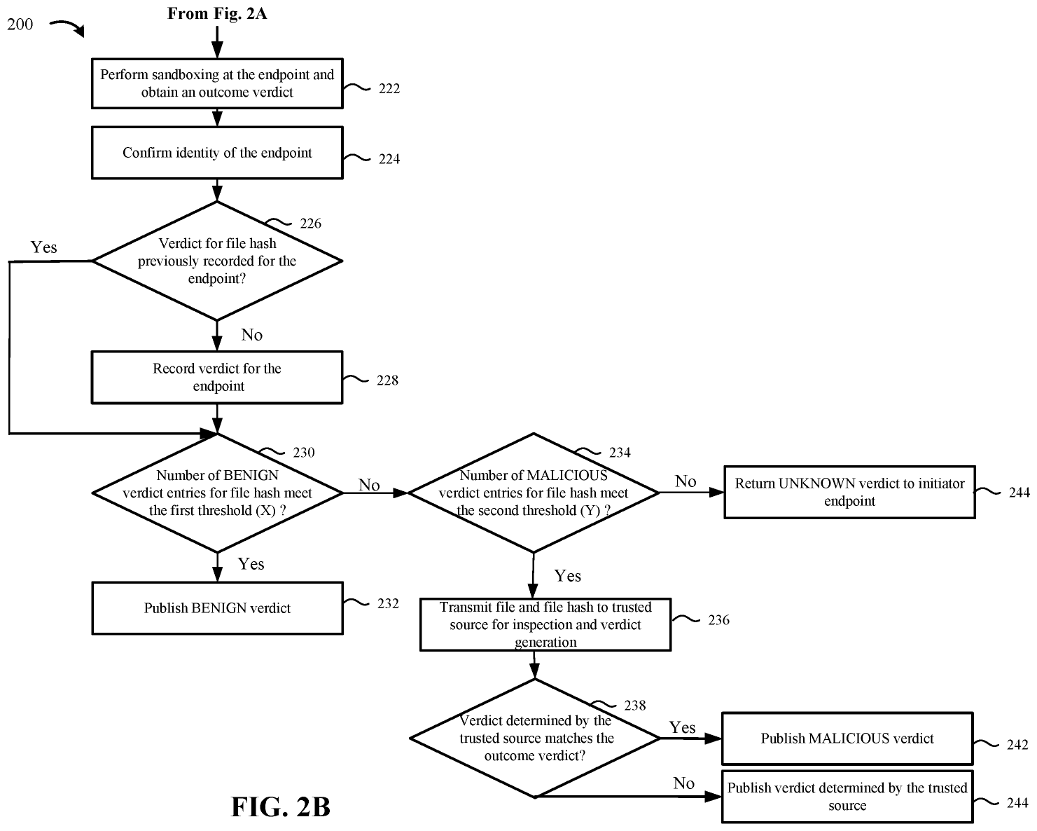

FIGS. 2A and 2B illustrate an example workflow 200 for evaluating files in a distributed malware detection system, according to an example embodiment of the present disclosure. Workflow 200 of FIG. 2 may be performed, for example, by components of networking environment 100 illustrated in FIG. 1.

Workflow 200 may be used to identify, generate, and/or report verdicts for files at one or more endpoints in a networking environment configured with distributed anti-malware capability. As used herein, an endpoint may be any device (e.g., host 110, ESG 122, etc. illustrated in FIG. 1) running an instance of a sandbox. In particular, anti-malware capability configured for the networking environment may be configured to find (e.g., and classify or reclassify) an inspected file is BENIGN when a first threshold number, X, of BENIGN verdicts are supplied for a same file, where each BENIGN verdict is supplied by a unique endpoint in the environment running an instance of a sandbox for isolating and examining files. Similarly, anti-malware capability configured for the networking environment may be configured to find (e.g., and classify or reclassify) an inspected file is MALICIOUS when a second threshold number, Y, of MALICIOUS verdicts are supplied for a same file, where each MALICIOUS verdict is supplied by a unique endpoint in the environment running an instance of a sandbox for isolating and examining files. Threshold numbers, X and Y, may be configured as integers greater than or equal to one. When the first threshold, X, is met for a file, the file is classified or reclassified as BENIGN, such as by a BENIGN verdict for that file being published to endpoints in the environment. On the other hand, when the second threshold, Y, is met for a file, the file is classified or reclassified as BENIGN, such as by a MALICIOUS verdict for that file being published to endpoints in the environment then. The threshold that is met first is used to determine whether the file is BENIGN or MALICIOUS. Publishing to endpoints in the environment may include broadcasting to all endpoints in the environment and/or inserting the verdict into a central repository, such as database 136, to allow for an endpoint to retrieve the verdict for a file (e.g., when a cache miss occurs which is described in more detail below). In particular, in some embodiments, MALICIOUS and BENIGN verdicts are published by broadcasting the verdict to all endpoints. In some embodiments, a MALICIOUS verdict is published by broadcasting the MALICIOUS verdict to all endpoints while a BENIGN verdict is published by inserting the BENIGN verdict into a central repository. In some embodiments, a MALICIOUS verdict is published by inserting the MALICIOUS verdict into a central repository while a BENIGN verdict is published by broadcasting the BENIGN verdict to all endpoints. In some embodiments, MALICIOUS and BENIGN verdicts are inserted into a central repository.

As an illustrative example, in a scenario where X is configured to be three and Y is configured to be two, either three BENIGN verdicts for a same file are needed before the file is deemed BENIGN or two MALICIOUS verdicts for the same file are needed before the file is deemed MALICIOUS. At a first time (t0), three verdicts may exist for the file, e.g., one verdict being from a first endpoint identifying the file as MALICIOUS and two verdicts being from two other endpoints identifying the file as BENIGN. Thus, at a later time (t1), where the same file is inspected by an additional endpoint that has not previously inspected the file, the verdict produced by this endpoint may determine whether the file is BENIGN or MALICIOUS. In one case, the additional endpoint may inspect the file and identify the file is MALICIOUS; thus, the second threshold may be met (e.g., two MALICIOUS verdicts now exist for this file), and the file may be deemed MALICIOUS. However, in another case, the additional endpoint may inspect the file and identify the file is BENIGN; thus, the second threshold may be met (e.g., three BENIGN verdicts now exist for this file), and the file may be deemed BENIGN.

As described in more detail below, where each of these thresholds (e.g., the first threshold, X, for BENIGN verdicts or the second threshold, Y, for MALICIOUS verdicts) are not met, an UNKNOWN verdict may be associated with the inspected file regardless of whether BENIGN verdict(s) have been supplied by one or more endpoints (e.g., less than the first threshold, X) or MALICIOUS verdict(s) have been supplied by one or more endpoints (e.g., less than the second threshold, Y) in the environment.

In certain embodiments, the first threshold number, X, may be configured as a value representative of a majority of endpoints in the environment running an instance of a sandbox. For example, where five endpoints are running an instance of a sandbox, X may be set to a value of three such that a file is not determined to be BENIGN until at least a majority, e.g., three endpoints of the five endpoints, produce a BENIGN verdict for the file. Accordingly, where the number of endpoints in the environment running an instance of a sandbox is equal to (2N+1), the first threshold value, may be equal to (N+1) (e.g., 5 endpoints=(2N+1) meaning (N=2) such that the first threshold value, (N+1) or (2+1), is equal to 3).

In certain embodiments, the second threshold number, Y, may be equal to one to ensure that MALICIOUS files are always blocked regardless of whether the MALICIOUS file verdict is returned from a compromised endpoint, or not, to maintain the integrity of the environment. For example, in a scenario where X is configured to be ten and Y is configured to be one, either ten BENIGN verdicts for a same file are needed before the file is deemed BENIGN or only one MALICIOUS verdict for the same file is needed before the file is deemed MALICIOUS. As long as an endpoint in the environment produces a MALICIOUS verdict for a file and a minimum of ten endpoints in the environment have not previously identified the file to be BENIGN, then the file will be deemed MALICIOUS.

Workflow 200 may begin, at operation 202, by an endpoint, such as VM 112 on host 110 or ESG 122 in data center 102 illustrated in FIG. 1, downloading one or more files. In some other cases (not shown), workflow 200 may begin by a file being added to a host 110 or ESG 122, prior to execution of a file on a host 110 or ESG 122, and/or the like. While the illustrated example assumes only one file is downloaded at the endpoint, in some other cases, multiple files may be downloaded at the endpoint and each file analyzed using workflow 200. The endpoint downloading the file may be referred to herein as the initiator endpoint given a file download initiates workflow 200 for malware detection. At operation 204, a hash is calculated for the downloaded file. In particular, for each file, a corresponding unique hash of the file may be generated, for example by using a cryptographic hashing algorithm such as the SHA-1 algorithm.

At operation 206, the calculated hash is passed to a security hub. The security hub may be a security hub implemented at the initiator endpoint or another endpoint (e.g., in cases where the initiator endpoint is not configured with a security hub). For example, the security hub may be security hub 114 implemented on host 110 as illustrated in FIG. 1 when the initiator endpoint is a VM 112 on host 110 where security hub 114 is implemented or a VM 112 on host 110 where security hub 114 is not implemented. In some other examples, the security hub may be security hub 124 implemented on ESG 122 as illustrated in FIG. 1, such as when the initiator endpoint is ESG 122. Accordingly, though certain processes for retrieving verdicts, performing sandboxing, etc., are described as occurring at the initiator endpoint, they may instead occur at a different endpoint. As mentioned, security hubs 114, 124 may be configured to retrieve verdicts for known files (files known to be BENIGN or MALICIOUS based on prior inspection for malware content) from a cache at the initiator or other endpoint storing hash values and verdicts for previously inspected files. For example, the cache may be ASDS cache 118 at host 110 illustrated in FIG. 1 when the initiator or other endpoint is a VM 112 on host 110. In some other examples, the cache may be ASDS cache 128 at ESG 122 illustrated in FIG. 1 when the endpoint is ESG 122. ASDS caches 118, 128 may store verdicts (and associated security attributes) for files (e.g., each identified by a unique hash value) that have been published to endpoints in the environment. As mentioned herein, a BENIGN file verdict for a file is published to endpoints in the environment when a first threshold number, X, of BENIGN verdicts are supplied for the file (e.g., each BENIGN verdict supplied by a different endpoint in the environment) or a MALICIOUS file verdict for the file is published to endpoints in the environment when a second threshold number, Y, of MALICIOUS verdicts are supplied for the file (e.g., each BENIGN verdict supplied by a different endpoint in the environment). ASDS caches 118, 128 make verdicts for previously inspected files readily available such that requests for a file verdict are returned faster than having to access the endpoint's primary storage location. In other words, ASDS caches 118, 128 allow endpoints to efficiently reuse previously determined and published verdicts for files inspected in the environment.

Accordingly, at operation 208, security hub 114 or security hub 124 uses the calculated file hash to search ASDS cache 118 or ASDS cache 128 at the endpoint where security hub 114 or security hub 124 is implemented. Where at operation 210 the hash value is located in the cache (e.g., no cache miss), at operation 212, the verdict associated and stored with the hash value is retrieved. In cases where the endpoint retrieving the verdict is not the initiator endpoint, the retrieved verdict may be returned to the initiator endpoint to take appropriate action with respect to the file.

Verdicts stored in the cache may be either BENIGN or MALICIOUS verdicts. Accordingly, where a BENIGN verdict is stored for the file hash, at operation 214, initiator endpoint may take a first policy action. The first policy action may be determined based on policies configured for endpoints in the environment at network manager 106. For example, initiator endpoint may be configured to allow a file download, open a file, execute a file, and/or the like, where a BENIGN verdict is returned for the file hash. Similarly, where a MALICIOUS verdict is stored for the file hash, at operation 216, initiator endpoint may take a second policy action. The second policy action may be determined based on policies configured for endpoints in the environment at network manager 106. For example, initiator endpoint may be configured to reset a connection, quarantine the file, delete the file, not allow the file to run, and/or the like, where a MALICIOUS verdict is returned for the file hash.

Alternatively, if the file hash for the file is not located in the cache (e.g., ASDS cache 118 or ASDS cache 128), the file may be considered to be an unknown file, or in other words the file is classified as an unknown file. In particular, the file is considered to be unknown because a first threshold number, X, of endpoints have not inspected the file and found the file to be BENIGN nor have a second threshold number, Y, of endpoints inspected the file and found the file to be MALICIOUS. Accordingly, a verdict for the file does not exist in the cache thereby making the file “unknown”.

If, at operation 210, the requested file hash is not found in the cache, in other words a cache miss occurs, then at operation 218, security hub 114 or 124 may select the unknown file for sandboxing and trigger initiation of the sandboxing process (e.g., the operations shown in FIG. 2B). More specifically, security hub 114 or 124 may pass the file (and its associated hash) to a sandboxing analyzer (e.g., such as sandboxing analyzer 116 at host 110 or sandboxing analyzer 126 at ESG 122 illustrated in FIG. 1) to perform static and dynamic analysis on the unknown file. Static and dynamic analysis may be performed on the unknown file to inspect the file for malicious content and produce a corresponding verdict based on the inspection.

However, prior to performing sandboxing on the unknown file, at operation 220, the sandboxing analyzer may determine whether the file hash exists in a database stored at security analyzer 132, and where the file hash exists in the database, determine whether other verdict source entries exist for the file hash. Other verdict source entries that exist in the database may include verdicts for files that have been previously inspected by one or more other trusted sources. As mentioned previously, examples of trusted sources that may be used to inspect files and provide verdicts stored in the database include Lastline cloud services 154 and Carbon Black cloud services 156 made commercially available from VMware, Inc. of Palo Alto, Calif. A verdict from another trusted source found in the database may indicate that this file has been previously inspected by the other trusted source but not published to endpoints in the environment (e.g., given at operation 210 a cache miss occurred).

Verdicts produced by Lastline cloud services 154 and/or Carbon Black cloud services 156 may be stored in database 136 and take precedence over verdicts produced by endpoints in the environment. Thus, at operation 220, where one or more other verdict source entries exist for the file hash in database 136, at operation 212, the one or more verdicts from the trusted source(s) associated and stored with the hash value are retrieved. Verdicts produced by other trusted sources may be either BENIGN or MALICIOUS verdicts. Accordingly, where a BENIGN verdict is stored for the file hash, at operation 214, initiator endpoint may take a first policy action, and where a MALICIOUS verdict is stored for the file hash, at operation 216, initiator endpoint may take a second policy action.

Determining whether verdicts from other trusted sources have been published to database 136 for a file prior to performing sandboxing on the file may save resources at the endpoint performing the sandboxing. In particular, given other source verdicts are more trusted and given precedence over verdicts produced by endpoints in the environment, the endpoint may save compute resources and power by adopting the verdict produced by the other trusted sources. However, while FIGS. 2A and 2B illustrate checking whether other verdict source entries exist at operation 220 prior to performing sandboxing at operations 222-238 (described in detail below), in some other cases, operation 220 may be performed asynchronously with operations 222-238.

Where, at operation 220, one or more other verdict source entries do not exist for the file hash, then at operation 222 (shown in FIG. 2B), sandboxing analyzer 116, 126 may perform sandboxing on the file to obtain an outcome verdict. In particular, an endpoint through sandboxing analyzer 116, 126 may inspect and test the file to better understand characteristics and behaviors of the file to categorize the file as “safe” (e.g., BENIGN) or “unsafe” (e.g., MALICIOUS). The endpoint may produce an outcome verdict for the file following this analysis. The outcome verdict may be stored in database 136 at security analyzer 132.

In certain embodiments, the outcome verdict associated with this file may be stored in inspection events table 138 of database 136 illustrated in FIG. 1. Inspection events table 138 may include verdicts for files that have been inspected but not published to endpoints in the environment, as well as verdicts for files that have been inspected and published to endpoints in the environment. In particular, inspection events table 138 may store verdict(s) for a file that has been inspected but not published to endpoints in the environment when a first threshold number, X, of BENIGN verdicts have not been returned (e.g., by different endpoints in the environment who have inspected the file) for the file, nor has a second threshold number, Y, of MALICIOUS verdicts been returned (e.g., by different endpoints in the environment who have inspected the file) for the file. As an illustrative example, where endpoints A, B, C, D, and E are running instances of the sandbox and the first threshold number, X, is configured to be three, and the second threshold number, Y, is configured to be one, either three endpoints need to inspect a file and publish a BENIGN verdict for the file before the file is published to all endpoints in the environment or one endpoint needs to publish a MALICIOUS verdict for the file before the file is published to all endpoints in the environment. Where the file has been inspected, but less than three endpoints have published a BENIGN verdict after inspecting the file and no endpoint has published a MALICIOUS verdict after inspecting the file, such verdicts for this file are stored and maintained in inspection events table 138.

Before the verdict associated with the file is added to database 136, and in some cases inspection events table 138, at operation 224, the identity of the endpoint is confirmed. Specifically, the system performs a check to ensure the endpoint producing the verdict is indeed the endpoint it is portraying to be and not an impersonator of the endpoint. In certain embodiments, authentication mechanisms, such as certificate verification, token authentication, and/or the like may be used to ensure the endpoint producing the verdict is not an impersonator of the endpoint. Where the endpoint is determined to be suspect and/or compromised, the outcome verdict associated with the file hash may be omitted and not added to inspection events table 138.

Where, at operation 224, the endpoint is determined to be a trusted endpoint, the outcome verdict associated with the file hash is either (1) added to an existing table for the file hash in database 136, or in some cases inspection events table 138, (2) added to a new table for the file hash created in database 136, or in some cases inspection events table 138, to store the verdict, or (3) skipped and not added to an existing table for the file hash. In particular, each time a file is first inspected by an endpoint in the environment, its corresponding hash is used to create a table in database 136 or inspection events table 138 in database 136. Alternatively, where the file has previously been inspected by an endpoint and is now inspected by a different endpoint, a table in database 136 or inspection events table 138 may already exist (and include the verdict from the first endpoint who inspected the file).

In some embodiments, the table for the file hash may include (2N+1) rows corresponding to the (2N+1) number of unique endpoints in the environment running an instance of a sandbox. Each row of a table created for a file hash may store an endpoint identifier (ID) (e.g., endpoint name) and a verdict produced for the file associated with the file hash. Each table may only have one verdict per endpoint stored for the file associated with the table. In some embodiments, the table for the file hash may be dynamic such that each time the file associated with the file hash of the table is inspected by a different endpoint, a new row is added to the table to store an endpoint ID (e.g., endpoint name) and the verdict produced by that endpoint.

Accordingly, at operation 226, where the endpoint previously inspected the same file and a verdict produced by the endpoint was recorded for the file in database 136 (or inspection events table 138), the new verdict determined at operation 222 may not be added to the table. In certain embodiments, where the new verdict determined at operation 222 is different than the verdict previously recorded in database 136 for the endpoint, the new verdict may be added to database 136 to replace the previously stored verdict. Further, in certain embodiments, where the endpoint has previously produced a verdict for the same file, the endpoint does not inspect the file again, and instead assumes the same verdict as previously produced. Alternatively, at operation 226, where a verdict produced by the endpoint for the file hash had not been previously been recorded in database 136 (or inspection events table 138), at operation 228, the verdict is recorded in an existing or new table created for the file hash.

According to certain embodiments, inspection events table 138 may provide a repository of verdicts for an inspected file to more easily determine whether a verdict is to be published to endpoints in the environment. Because BENIGN verdicts are only published to endpoints in the environment when X BENIGN verdicts are supplied for a same file by different endpoints and MALICIOUS verdicts are only published when Y MALICIOUS verdicts are supplied for a same file by different endpoints, inspection events table 138 may be designed to allow only one verdict per endpoint per file. In particular, by not allowing duplicate verdicts from a same endpoint for a same file to be recorded in inspection events table 138, duplicate verdicts from a same endpoint do not cause a verdict to become published. In particular, the threshold for publishing a verdict is set to ensure that a compromised endpoint producing a compromised verdict does not infiltrate the system. Thus, the threshold for publishing a verdict is only met when enough verdicts from different endpoints are published. For example, where the first threshold number, X, for publishing a BENIGN verdict is three, inspection events table 138 is designed to require three different endpoints publishing a BENIGN verdict before the BENIGN verdict is published to all endpoints in the system, as opposed to the same endpoint (and possibly compromised endpoint) publishing a BENIGN verdict for the same file three different times. In other words, in certain aspects, each of a plurality of endpoints is configured to generate verdicts of benign or malicious for a file and at most one verdict of benign or malicious for the file per endpoint is used in determining whether and aggregate number of verdicts for the file meet a threshold as further discussed herein.

At operation 230, security analyzer 132 may check whether BENIGN verdicts exist for the file hash, and where they exist, further determine a number of BENIGN verdict entries for the file hash. For example, the aggregate number of BENIGN verdict entries for the file hash may be checked to determine whether the number of BENIGN verdict entries for the file hash meets the first threshold, X (e.g., is equal to X). In other words, where a number of BENIGN verdict entries for the file hash is equal to X, the first threshold is satisfied at operation 230, and a BENIGN verdict may be published to all endpoints in the environment. Accordingly, at operation 232, the BENIGN verdict is published. Each endpoint may trust this verdict and take appropriate policy action, where necessary. In some embodiments, when the BENIGN verdict is broadcast to all endpoints, the BENIGN verdict for this file and its file hash may be stored in ASDS 118 and/or ASDS 128 on each endpoint. In some embodiments, when the BENIGN verdict is stored in a central repository, such as database 136, when an endpoint pulls the BENIGN verdict from the central repository (e.g., when a cache miss occurs), the BENIGN verdict may be stored in ASDS 118 or ASDS 128.

If at operation 230, a number of BENIGN verdicts for the file hash does not meet the first threshold, X, at operation 234, security analyzer 132 may check whether MALICIOUS verdicts exist for the file hash, and where they exist, further determine a number of MALICIOUS verdict entries for the file hash. For example, the aggregate number of MALICIOUS verdict entries for the file hash may be checked to determine whether the number of MALICIOUS verdict entries for the file hash meets the second threshold, Y (e.g., is equal to Y). In other words, where a number of MALICIOUS verdict entries for the file hash is equal to y, the second threshold is satisfied at operation 234. Accordingly, at operation 236, the endpoint may transfer the file and associated file hash to at least one trusted cloud service, such as Lastline cloud services 154 and/or Carbon Black cloud services 156, for inspection. After the file has been inspected by the trusted source, the verdict produced for the file is transferred back to the endpoint. It should be noted that reference in the claims to a “first threshold” may refer to either of the first threshold X or the second threshold Y, and an aggregate number of verdicts for the file may refer to either of an aggregate number of MALICIOUS verdict entries or an aggregate number of BENIGN verdict entries.

At operation 238, where the verdict determined by the trusted source matches the outcome verdict generated by the endpoint (e.g., both the endpoint and the trusted source produce a MALICIOUS verdict for the file), at operation 240, the MALICIOUS verdict is published (e.g., in some cases, broadcast to all endpoints in the environment). Each endpoint may trust this verdict and take appropriate policy action, where necessary. In some embodiments, when the MALICIOUS verdict is broadcast to all endpoints, the MALICIOUS verdict for this file and its file hash may be stored in ASDS 118 and/or ASDS 128 on each endpoint. In some embodiments, when the MALICIOUS verdict is stored in a central repository, such as database 136, when an endpoint pulls the MALICIOUS verdict from the central repository (e.g., when a cache miss occurs), the MALICIOUS verdict may be stored in ASDS 118 or ASDS 128.

On the other hand, where the verdict determined by the trusted source does not match the outcome verdict generated by the endpoint (e.g., both the endpoint and the trusted source do not produce a MALICIOUS verdict for the file), at operation 242, the verdict determined by the trusted source is published.

Although workflow 200 illustrates operation 234 occurring after operation 230, in some embodiments, security analyzer may perform operation 234 prior to performing operation 230 such that security analyzer determines whether the second threshold, Y, is met prior to determining whether the first threshold, X, is met. While workflow 200 illustrates only MALICIOUS verdicts are verified by other trusted sources, in some embodiments, BENIGN verdicts may be sent to at least one other trusted source for verification prior to publishing the verdict to endpoints in the environment (e.g., where the number of BENIGN verdicts for a same file meets the X threshold) in a similar manner.

Returning to operation 234, if a number of MALICIOUS verdicts for the file hash does not meet the second threshold, Y, (and also a number of BENIGN verdicts for the file hash does not meet the first threshold, X, at operation 230), at operation 244, an UNKNOWN verdict is returned to the initiator endpoint. In particular, because a first threshold number of endpoints configured for the anti-malware system have not inspected the file and produced a common BENIGN verdict, nor has a second threshold number of endpoints configured for the anti-malware system inspected the file and produced a common MALICIOUS verdict, no conclusive verdict may be returned to the initiator endpoint, or other endpoints in the environment for that matter. Where an UNKNOWN verdict is returned for the file hash, an initiator endpoint may take a third policy action. The third policy action may be determined based on policies configured for endpoints in the environment at network manager 106. For example, initiator endpoint may be configured to allow a file download, open a file, execute a file, reset a connection, quarantine the file, delete the file, etc. based on the configured policies.

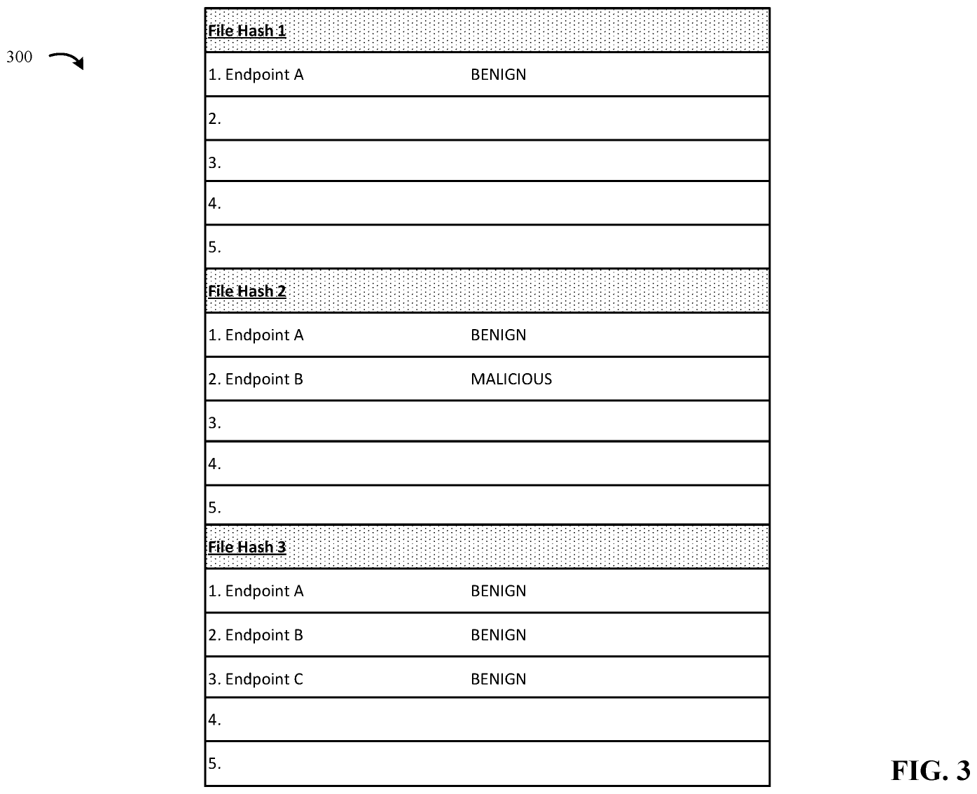

Determining when to return an UNKNOWN verdict to an initiator endpoint, when to publish a MALICIOUS verdict to all endpoints in the environment, and when to publish a BENIGN verdict to all endpoints in the environment may be explained in more detail with respect to the example inspection events table 300 of FIG. 3. FIG. 3 illustrates an example table 300 of verdicts for files evaluated in the distributed malware detection system, according to an example embodiment of the present application.

As shown in FIG. 3, three files (e.g., each associated with one of File Hash 1, File Hash 2, and File Hash 3) may have been previously inspected by endpoints in networking environment 100 of FIG. 1. Each file may have its own respective table in table 300 with rows for storing verdicts produced by each endpoint that inspects the file associated with the file hash of the table. Each row may store an endpoint ID (e.g., endpoint name) and a verdict produced by that endpoint for the file inspected. As mentioned previously, each table may only have one verdict per endpoint stored for the file associated with the table.

In the example shown in FIG. 3, the first threshold, X, may be configured to be three, and the second threshold, Y, may be configured to be one. Further, an example table for each file hash may include five rows representing five different endpoints in the environment running an instance of a sandbox. However, in some cases, the rows of the table may be dynamic such that each time a new endpoint inspects the file a new row is added, or there may be a different number of rows.

As shown in FIG. 3, Endpoint A may be the only endpoint which has inspected the file associated with File Hash 1. The verdict published by Endpoint A is BENIGN and is recorded in table 300. After this verdict recorded in table 300, the number of verdict entries for File Hash 1 recorded in table 300 is checked to determine whether a number of verdicts recorded for the file hash is equal to the first threshold X (e.g., similar to operation 230 of FIG. 2B) or equal to the second threshold Y (e.g., similar to operation 234 of FIG. 2B). Because the number of BENIGN verdict entries recorded for File Hash 1 is only one, the first threshold, X (e.g., three), is not met. Further, because the number of MALICIOUS verdict entries recorded for File Hash 1 is zero, the second threshold, Y (e.g., one), is also not met. Thus, at least for File Hash 1, an UNKNOWN verdict would be returned to an initiator endpoint (e.g., in this case, Endpoint A since Endpoint A is the only endpoint which has inspected the file).

Further, as shown in FIG. 3, Endpoint A and Endpoint B may both have inspected the file associated with File Hash 2. The verdict published by Endpoint A is BENIGN while the verdict published by Endpoint B is MALICIOUS. Each of these verdicts for File Hash 2 are recorded in the table for File Hash 2. Because the number of BENIGN verdict entries recorded for File Hash 2 is only one, the first threshold, X (e.g., three), is not met. However, because the number of MALICIOUS verdict entries recorded for File Hash 2 is one, the second threshold, Y (e.g., one), is met. Similar to operation 236 of FIG. 2B, where the second threshold is met, the file and its associated file hash is transferred to at least one trusted cloud service, such as Lastline cloud services 154 and/or Carbon Black cloud services 156, for inspection and verdict generation. Where the trusted source also classifies the file as MALICIOUS, the MALICIOUS verdict is published. For this example, a single MALICIOUS verdict produced for a file is enough to deem the file as MALICIOUS and publish the MALICIOUS verdict to all endpoints in the environment because the second threshold, Y, is equal to one.

Further, as shown in FIG. 3, Endpoint A, Endpoint B, and Endpoint C may have all inspected the file associated with File Hash 3. The verdict published by Endpoint A is BENIGN, the verdict published by Endpoint B is BENIGN, and the verdict published by Endpoint C is BENIGN. Each of these verdicts for File Hash 3 is recorded in the table for File Hash 3. Unlike File Hash 1, the number of BENIGN verdict entries recorded for File Hash 3 is sufficient to meet the first threshold, X. More specifically, the number of BENIGN verdict entries recorded for File Hash 3 is equal to the three BENIGN verdicts required for File Hash 3 before the BENIGN verdict is able to be published to all endpoints. Thus, for File Hash 3, a BENIGN verdict is published.

As mentioned herein, other trusted source verdicts, such as verdicts from Lastline cloud services 154 and/or Carbon Black cloud services 156, for inspected files may be stored in database 136. Verdicts published by these other sources may not be directly transmitted from these other sources to database 136 for storage but instead be transmitted to database 136 for storage via an endpoint which submitted the file to these other sources for inspection. In particular, where a file is to be inspected by Lastline cloud services 154, an endpoint requesting the file be inspected (e.g., referred to herein as the requesting endpoint) may transfer the file directly to Lastline cloud services 154, as opposed to first transferring the file to security analzyer 132 and then to Lastline cloud services 154 for inspection. After the file has been inspected by Lastline cloud services 154, a verdict produced for the file is transferred back to the requesting endpoint. The requesting endpoint may transfer this verdict to database 136 of security analzyer 132 for storage. Prior to storage at database 136, however, security analzyer 132 may confirm the identity of the requesting endpoint to ensure that the requesting endpoint producing the verdict is indeed the endpoint it is portraying to be and not an impersonator of the endpoint.

For example, communications between a requesting endpoint and Lastline cloud services 154 may be susceptible to man-in-the-middle (MITM) attacks where an attacker intercepts communications between the two parties for purposes of modifying communications between the two parties to infiltrate the system. In this case, an attacker purporting to be the requesting endpoint might produce a verdict for storage at database 136 which the attacker claims to be from Lastline cloud services 154 when it is in fact a verdict for a file that Lastline cloud services 154 has neither inspected nor produced a verdict for. In some cases, the attacker may request security analyzer 132 store a fake BENIGN verdict associated with a MALICIOUS file for storage at database 136, claiming the verdict is from Lastline cloud services 154, to gain unauthorized access into the system.

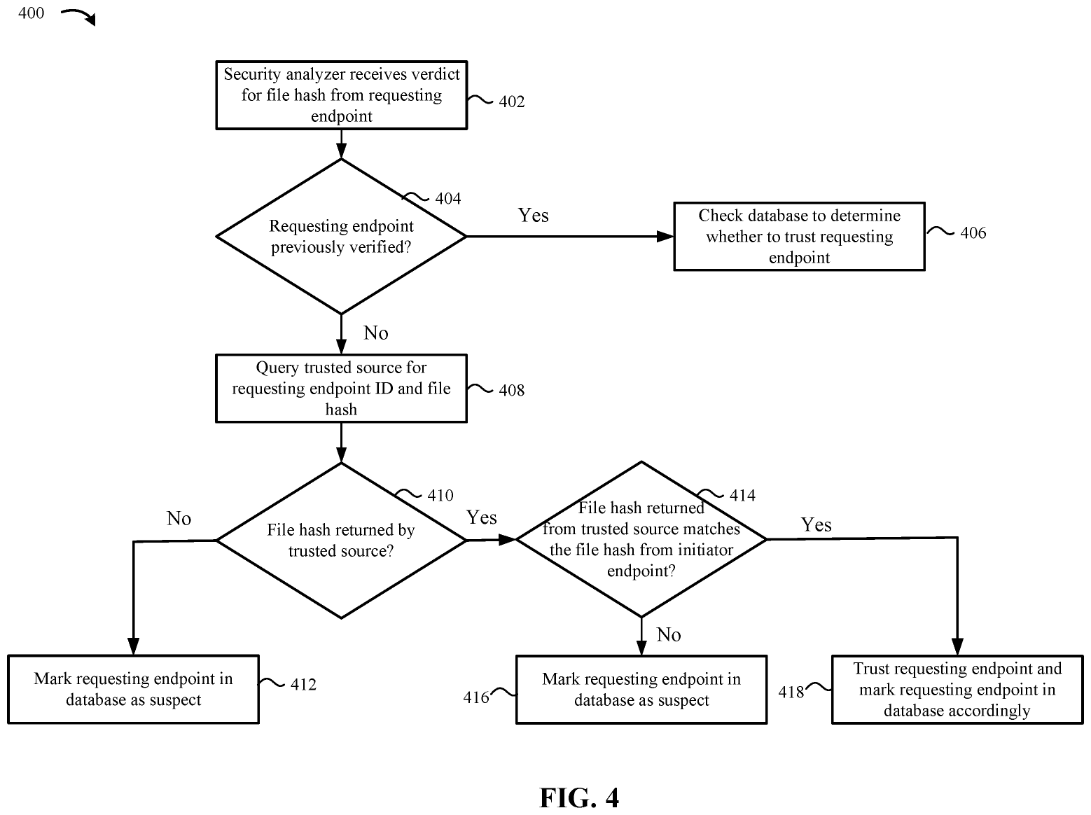

For this reason, in certain embodiments, security analzyer 132 is configured to confirm the identity of the requesting endpoint prior to storage of a verdict that the requesting endpoint is claiming to be from a trusted source, such as Lastline cloud service 154 or Carbon Black cloud services 156. As will be described in more detail below with respect to FIG. 4, verification of the identity of a requesting endpoint may be performed each time a new requesting endpoint provides a verdict to security analyzer 132.

FIG. 4 illustrates an example workflow 400 for confirming endpoint identity, according to an example embodiment of the present disclosure. Workflow 400 of FIG. 4 may be performed, for example, by security analyzer 132 of networking environment 100 illustrated in FIG. 1.

Workflow 400 may begin, at operation 402, by security analyzer 132 receiving a verdict for a file hash from an endpoint claiming to be a requesting endpoint (e.g., an endpoint having a verdict for a file which the endpoint requested to be analyzed by a trusted cloud service). Prior to storage of the verdict received, security analyzer 132 determines whether the requesting endpoint is to be trusted. In making this determination, security analyzer 132, at operation 404, determines whether the identity of the requesting endpoint had previously been verified. Previously verified endpoints are endpoints which at a prior time submitted a verdict for storage at database 136 and were analyzed by security analyzer 132 to identify whether the endpoint could be trusted. This prior determination is stored for the endpoint in database 136.

Accordingly, where at operation 404 security analyzer 132 determines the requesting endpoint was previously verified, then at operation 406, security analyzer 132 checks database 136 to determine whether to trust the requesting endpoint. If the requesting endpoint is marked as a trusted source in database 136, security analyzer 132 may accept the verdict supplied by the requesting endpoint and add this verdict to database 136 for its associated file hash. On the other hand, if the requesting endpoint is marked as a suspect source in database 136, security analyzer 132 may not accept the verdict supplied by the requesting endpoint. Accordingly, the verdict may not be stored in database 136.

Returning to operation 404, where security analyzer 132 determines the requesting endpoint was not previously verified, at operation 408, security analyzer 132 queries the trusted source (e.g., the trusted source for which the requesting endpoint is claiming the verdict to be from) for the requesting endpoint ID and file hash associated with the verdict. A file hash matching the file hash for the verdict that is returned by the trusted source may indicate to security analyzer 132 that the requesting endpoint can be trusted given the trusted source has record of the file hash the requesting endpoint is claiming to have been previously inspected by the trusted source.

Thus, at operation 410, where the trusted source does not return a file hash for the requesting endpoint ID, at operation 412, security analyzer 132 marks the requesting endpoint in database 136 as suspicious. Further, security analyzer 132 does not accept the verdict supplied by the requesting endpoint. Alternatively, at operation 410, where the trusted source does return a file hash for the requesting endpoint, at operation 414, security analyzer 132 checks whether the returned file hash matches the file hash for the verdict supplied by the requesting endpoint.

If the file hash returned from the trusted source does not match the file hash for the verdict, at operation 416, security analyzer 132 marks the requesting endpoint in database 136 as suspicious and does not accept the verdict supplied by the requesting endpoint. Alternatively, if the file hash returned from the trusted source does match the file hash for the verdict, at operation 418, security analyzer 132 determines the requesting endpoint can be trusted and marks the requesting endpoint in database 136 accordingly. Further, security analyzer may accept the verdict supplied by the trusted, requesting endpoint and add this verdict to database 136 for its associated file hash.

In certain embodiments, periodic integrity checks of endpoints at random and/or periodic integrity checks of endpoints with minority verdicts may be implemented in data center 102. A minority verdict is a verdict for a file hash that is different than a verdict for the file hash supplied by a majority of endpoints in the data center. In some cases, the integrity check may be initiated by transmitting a file with a known verdict (e.g., BENIGN or MALICIOUS) to a selected endpoint (e.g., selected at random or selected based on a minority verdict) for analysis. The verdict produced by the selected endpoint may be compared to the known verdict for the file to identify whether the endpoint is compromised, or not. The known verdict, for example, may be a verdict for the file produced by a trusted source, such as Lastline cloud services 154 and/or Carbon Black cloud services 156. Information from this analysis may be supplied to a user and/or administrator to provide additional information regarding an endpoint so that a user and/or administrator may take appropriate action (e.g., fix issues) with respect to the endpoint, where necessary.

In certain embodiments, where a particular endpoint is marked as suspect and/or compromised, then files sent to sandboxing analyzer 116 or sandboxing analyzer 126 may be extracted and sent to one or more other trusted sources for independent inspection. Additional configuration may be implemented to allow such files to be extracted from the endpoint and transmitted to the one or more other trusted sources in a way that does not leverage components on that endpoint given that endpoint is likely compromised.

In certain embodiments, a heuristic evaluation may be implemented to identify any endpoint producing a number of minority verdicts equal to or above a threshold (e.g., an integer greater than or equal to one). In some cases, the threshold may be set to one, such that any endpoint producing a single minority verdict may be identified. Such endpoints that are identified based on this threshold value may be marked as suspect and their verdicts omitted from inspection events table 138.

In certain embodiments, a heuristic evaluation may be implemented to identify any file for which a large number of endpoints in data center 102 are requesting verdicts for (e.g., by first checking ASDS cache 118 and/or ASDS cache 128). Identified files may be marked for independent verification. In other words, identified files may be transferred to Lastline cloud services 154 and/or Carbon Black cloud services for inspection and verdict generation.

In certain embodiments, periodic security audits/scans on endpoints in data center 102 may be implemented using a guest introspection (GI) security solution. GI offloads antivirus and anti-malware agent processing to a dedicated secure virtual appliance. Since the secure virtual appliance (unlike a guest VM) doesn't go offline, the secure virtual appliance can continuously update antivirus signatures thereby giving uninterrupted protection to the VMs. To implement the security solution, GI agents are installed to analyze the endpoints in data center 102, as well as monitor and scan any files on these endpoints.

According to certain aspects described herein, after a threshold amount of endpoints have inspected a file and produced a same verdict, the verdict is published for use by all endpoints in data center 102. In certain embodiments, however, the usage scope for a verdict may dynamically change (e.g., increase and/or decrease). In particular, in some cases, all endpoints in the data center may use the verdict, while in some other cases, one or only a subset of endpoints in data center 102 may use the verdict. In some cases, endpoints in data center 102 may be grouped into one or more logical groups based on tenancy, type of endpoint (e.g., SVM, ESG), class of workload, and/or any other factor which a user or administrator may choose. Accordingly, a verdict produced by an endpoint in a logical group may be shared to and used by other endpoints in that first logical group but not endpoints belonging to another logical group. However, verdicts that are independently computed and returned by Lastline cloud service 154 and/or Carbon Black cloud services 156 may be shared across the logical groups.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for detecting malware in a distributed malware detection system comprising a plurality of endpoints, the method comprising:
inspecting, at a first endpoint of the plurality of endpoints, a file classified as an unknown file;
based on the inspecting, determining, at the first endpoint, a first verdict for the file, the first verdict indicating the file is benign or malicious;
determining whether an aggregate number of verdicts for the file from the plurality of endpoints, including the first verdict, meets a first threshold; and
selectively reclassifying the file as benign or malicious based on whether the aggregate number of verdicts for the file meets the first threshold.

2. The method of claim 1, wherein each of the plurality of endpoints is configured to generate verdicts of benign or malicious for the file and at most one verdict of benign or malicious for the file per endpoint is used in determining whether the aggregate number of verdicts for the file meet the first threshold.

3. The method of claim 1, wherein the first threshold is a threshold number of benign verdicts, wherein determining whether the aggregate number of verdicts meets the first threshold comprises determining whether an aggregate number of benign verdicts meets the first threshold, and wherein the selectively reclassifying further comprises when the first threshold is met, reclassifying the file as benign.

4. The method of claim 1, wherein the first threshold is a threshold number of malicious verdicts, wherein determining whether the aggregate number of verdicts meets the first threshold comprises determining whether an aggregate number of malicious verdicts meets the first threshold, and wherein the selectively reclassifying further comprises when the first threshold is met, reclassifying the file as malicious.

5. The method of claim 1, wherein the selectively reclassifying comprises:
based on the aggregate number of verdicts meeting the first threshold, transmitting the file to a trusted source for inspection; and
reclassifying the file based on the first verdict and a verdict from the trusted source.

6. The method of claim 1, further comprising authenticating the first endpoint prior to including the first verdict in the aggregate number of verdicts.

7. The method of claim 1, wherein the file is classified as unknown based on a hash for the file not being associated with a classification at a cache at the first endpoint.

8. The method of claim 1, further comprising, prior to inspecting the file:
determining a trusted source has previously inspected a second file and produced a second verdict for the second file, wherein the second verdict was previously transmitted from the trusted source to an endpoint in the distributed malware detection system that has been confirmed to be a trusted endpoint, and wherein the second verdict classifies the second file as benign or malicious; and
classifying the second file based on the second verdict without inspecting the second file.

9. The method of claim 8, wherein the endpoint is confirmed to be the trusted endpoint when a query is sent to the trusted source and in response to the query, the trusted source produces a hash associated with the second file that matches a hash for the second file maintained by the endpoint.

10. The method of claim 1, further comprising publishing the reclassification of the file to a subset of endpoints in the distributed malware detection system, wherein the subset of endpoints comprises one or more endpoints belonging to a same group as the first endpoint.

11. A system comprising:
one or more processors; and
at least one memory, the one or more processors and the at least one memory configured to:
inspect, at a first endpoint of the plurality of endpoints, a file classified as an unknown file;
based on the inspecting, determine, at the first endpoint, a first verdict for the file, the first verdict indicating the file is benign or malicious;
determine whether an aggregate number of verdicts for the file from the plurality of endpoints, including the first verdict, meets a first threshold; and
selectively reclassify the file as benign or malicious based on whether the aggregate number of verdicts for the file meets the first threshold.

12. The system of claim 11, wherein each of the plurality of endpoints is configured to generate verdicts of benign or malicious for the file and at most one verdict of benign or malicious for the file per endpoint is used in determining whether the aggregate number of verdicts for the file meet the first threshold.

13. The system of claim 11, wherein the first threshold is a threshold number of benign verdicts, wherein determining whether the aggregate number of verdicts meets the first threshold comprises determining whether an aggregate number of benign verdicts meets the first threshold, and wherein the selectively reclassifying further comprises when the first threshold is met, reclassifying the file as benign.

14. The system of claim 11, wherein the first threshold is a threshold number of malicious verdicts, wherein determining whether the aggregate number of verdicts meets the first threshold comprises determining whether an aggregate number of malicious verdicts meets the first threshold, and wherein the selectively reclassifying further comprises when the first threshold is met, reclassifying the file as malicious.

15. The system of claim 11, wherein the selectively reclassifying comprises:
based on the aggregate number of verdicts meeting the first threshold, transmitting the file to a trusted source for inspection; and
reclassifying the file based on the first verdict and a verdict from the trusted source.

16. The system of claim 11, wherein the one or more processors and the at least one memory are further configured to authenticate the first endpoint prior to including the first verdict in the aggregate number of verdicts.

17. The system of claim 11, wherein the file is classified as unknown based on a hash for the file not being associated with a classification at a cache at the first endpoint.

18. The system of claim 11, wherein the one or more processors and the at least one memory are further configured to, prior to inspecting the file:
determine a trusted source has previously inspected a second file and produced a second verdict for the second file, wherein the second verdict was previously transmitted from the trusted source to an endpoint in the distributed malware detection system that has been confirmed to be a trusted endpoint, and wherein the second verdict classifies the second file as benign or malicious; and
classify the second file based on the second verdict without inspecting the second file.

19. The system of claim 18, wherein the endpoint is confirmed to be the trusted endpoint when a query is sent to the trusted source and in response to the query, the trusted source produces a hash associated with the second file that matches a hash for the second file maintained by the endpoint.

20. A non-transitory computer-readable medium comprising instructions that, when executed by one or more processors of a computing system, cause the computing system to perform operations for detecting malware in a distributed malware detection system comprising a plurality of endpoints, the operations comprising:
inspecting, at a first endpoint of the plurality of endpoints, a file classified as an unknown file;
based on the inspecting, determining, at the first endpoint, a first verdict for the file, the first verdict indicating the file is benign or malicious;
determining whether an aggregate number of verdicts for the file from the plurality of endpoints, including the first verdict, meets a first threshold; and
selectively reclassifying the file as benign or malicious based on whether the aggregate number of verdicts for the file meets the first threshold.
